(19) United States
(12) Patent Application Publication
(10) Pub. No.: US 2013/0162138 A1
(43) Pub. Date: Jun. 27, 2013

(54) DISPLAY DEVICE AND METHOD FOR PRODUCING THE SAME

(71) Applicant: SHINODA PLASMA CO., LTD., Kobe-shi (JP)

(72) Inventors: Bingang GUO, Kobe-shi (JP); Yosuke YAMAZAKI, Kobe-shi (JP); Terukazu KOSAKO, Kobe-shi (JP)

(73) Assignee: SHINODA PLASMA CO., LTD., Kobe-shi (JP)

(21) Appl. No.: 13/727,285

(22) Filed: Dec. 26, 2012

(30) Foreign Application Priority Data
Dec. 27, 2011 (JP) 2011-285973
Dec. 27, 2011 (JP) 2011-285980

(51) Int. Cl. H01J 17/49; H01J 9/20

(52) U.S. Cl. CPC H01J 17/49; H01J 9/20
USPC 313/493; 313/485; 445/24

(57) ABSTRACT

A display device includes a plasma tube array including a plurality of plasma tubes arranged in parallel; a plurality of display electrodes provided on a front side of the plasma tube array so as to be extended perpendicularly to a longitudinal direction of the plasma tubes; and a plurality of address electrodes provided on a rear side of the plasma tube array so that each address electrode is extended along each plasma tube longitudinally; each plasma tube having a tube, a discharge assisting film having a thickness different from part to part, and a phosphor film, wherein the discharge assisting film is provided on an inner surface of each tube, the thickness of the discharge assisting film is larger at the front side than at the rear side, and the phosphor film is formed on the discharge assisting film at the rear side.

### CROSS-REFERENCE TO RELATED APPLICATION

This application is related to Japanese Patent Applications Nos. 2011-285973 and 2011-285980 filed on Dec. 27, 2011, whose priorities are claimed under 35 USC §119, and the disclosures of which are incorporated by reference in their entirety.

### BACKGROUND OF THE INVENTION

1. Field of the Invention

The present invention relates to a display device. More particularly, the present invention relates to a display device of plasma tube array type comprising a plurality of light-emitting tubes arranged in parallel, each of which is composed of a thin tube provided with a discharge assisting film and a phosphor film on an inner surface thereof and filled with a discharge gas, and to a method for producing the same.

2. Description of the Related Art

Japanese Patent No. 3895202 (U.S. Pat. No. 6,893,677 B) discloses a display device known as the one utilizing technology referred to as “plasma tube array (PTA)”, which can be easily produced in large screen sizes.

This conventional display device comprising an array of a plurality of light-emitting tubes arranged in parallel, each of which is made of a glass thin tube having a diameter of 0.5 to 5 mm. The glass thin tube provides a discharge assisting film and a phosphor on an inner surface and being filled with a discharge gas. The array of the light-emitting tubes is sandwiched between a display electrode sheet on a front surface side and an address electrode sheet on a rear surface side. Conventionally, the light-emitting tube is referred to as “plasma tube”, and the discharge assisting film is referred to as “electron emission layer”.

More specifically, in the above-mentioned plasma tube array, the discharge assisting film made of magnesium oxide (MgO) having a uniform thickness is formed on the inner surface of each plasma tube, and the phosphor film is formed on the discharge assisting film at the non-display surface side of each plasma tube. The discharge assisting film provided on the inner surface of each plasma tube allows improvement in discharge characteristics such as lowering of the breakdown voltage. One conventional method for forming a discharge assisting film made of magnesium oxide is disclosed in Japanese Patent No. 4303925 (U.S. Pat. No. 7,208,203 B).

The display electrode sheet comprises a first support and a plurality of display electrode pairs formed on the first support so as to be extended perpendicularly to the plasma tubes and arranged in parallel in the longitudinal direction of the plasma tubes. The address electrode sheet comprises a second support and a plurality of address electrodes formed on the second support so that each address electrode is extended along each plasma tube.

The discharge assisting film in each plasma tube in this conventional display device is formed by injecting a material solution for forming the discharge assisting film into an glass thin tube through a bottom opening, and then applying negative pressure to the bottom opening and sucking out excess material solution in the thin tube through the bottom opening. Thus, a film of the material solution is formed on the inner surface of the thin tube. As the material solution, a magnesium caproate solution and a fatty acid magnesium solution may be used. As the solvent included in these solutions, ethanol and ethyleneglycol may be used.

Subsequently, a first heater and a second heater placed on a top periphery of the thin tube are gradually moved down toward a bottom periphery of the thin tube, while the bottom opening of the thin tube is kept under negative pressure. On this occasion, the viscosity of the film of the undried material solution is reduced by the action of the first and second heaters, and the material solution having the reduced viscosity trickles downward to make a pool, and as a result the hollow space inside the thin tube is clogged with the material solution. Since the bottom opening of the thin tube is constantly under negative pressure, the pool of the material solution (clogged region in the hollow space) is moved downward, during which the film of the material solution above the pool is dried to be a discharge assisting film (MgO film). Gathering as the pool, the material solution has the surface tension that acts evenly in the circumference direction of the thin tube, and therefore the film dried after the pool of the material solution has passed (discharge assisting film) can have a uniform thickness.

In this conventional display device, an area where an address electrode intersects a display electrode pair is a unit light emission area (generally called a discharge cell). Display is performed as follows. Using one electrode of a display electrode pair as a scanning electrode, a selection discharge is generated in an area where the scanning electrode intersects an address electrode to select a light emission area. Utilizing a wall charge formed by the selection discharge on the inner surface of the selected light emission area, a display discharge is generated between the display electrode pair on the selected cell. The display discharge causes generation of ultraviolet photons in the plasma tube, and the phosphor film generates a visible light by the ultraviolet excitation. Thus, the selected light emission area emits visible light.

The selection discharge is an opposed discharge generated within the plasma tube between the display electrode and the address electrode. The display discharge is a surface discharge generated within the plasma tube between the two display electrodes arranged as a pair in parallel on a plane. Instead of the display electrode pair, only one display electrode may be used, and both the selection discharge and the display discharge may be generated between the display electrode and the address electrode as the opposed discharge.

Advantageously, the PTA-type display device described above can be produced with a smaller-scale facility compared to display devices in a panel format such as PDPs and LCDs with the use of a large glass substrate, because it employs an elongated thin glass tube as a unit of the production. However, in the PTA-type display device, it is desired to solve the following problems:

(1) Costs need to be reduced by further improving the structure and production process in order to spread a market of this large screen display device.
(2) It is difficult to obtain discharge characteristics uniform throughout the entire length of plasma tubes elongated to be 1 or more meters long with the increase in display screen size. In particular, the discharge time lag varies from discharge point to discharge point in the longitudinal direction of the plasma tubes.

### SUMMARY OF THE INVENTION

The present inventors have pursued study of the cost reduction, focusing particularly on processing of the discharge assisting film of the display device of plasma tube array type. In the study, the present inventors noted that when a glass tube having a flattened or approximate quadrate cross section is used for the plasma tube, unlike the case of a glass tube having a circular cross section, a flat face of the flattened tube could be preliminarily determined to be positioned at a side of a display surface which is to contact display electrode pairs to be a discharge surface, and found a technical means for selectively forming a discharge assisting film having a necessary thickness on an inner surface of the plasma tube only in an area at the discharge surface side.

To put it simply, the present invention is characterized by a structure in which the discharge assisting film on the inner surface of the plasma tube has a smaller thickness in an area at the non-display surface side than in an area at the display surface side. This structure can be obtained by employing a new application method with a rotary table for so-called spin coating for the formation of the discharge assisting film. Thereby, the production process of the plasma tube can be simplified, and the material cost can be considerably reduced.

In addition, the present invention is to achieve discharge characteristics uniform throughout the entire length of the plasma tube. Furthermore, the present invention is to provide a display device of plasma tube array type capable of high-speed and reliable addressing by shortening the statistical discharge time lag in the discharge points in the longitudinal direction of the plasma tube.

According to an aspect of the present invention, therefore, there is provided a display device comprising: a plasma tube array including a plurality of plasma tubes arranged in parallel; a plurality of display electrodes provided on a front side of the plasma tube array so as to be extended perpendicularly to a longitudinal direction of the plasma tubes; and a plurality of address electrodes extended along each plasma tube longitudinally, wherein the plasma tubes each having a discharge assisting film provided on an inner surface of each tube, the thickness of the discharge assisting film is larger at the front side than at the rear side, and the phosphor film is formed on the discharge assisting film at the rear side.

The present invention can provide a plasma tube and a display device that allow cost reduction while maintaining good discharge characteristics by forming a discharge assisting film having a smaller thickness at the non-display surface side (rear side) than at the display surface side (front side). That is, the costs of expensive materials of the discharge assisting film can be reduced, because the area where the discharge assisting film is formed in the present invention is substantially half of that in a conventional case in which a discharge assisting film having a uniform thickness is formed on an entire inner surface of a plasma tube.

According to another aspect of the present invention, there is provided a display device comprising: a plasma tube array including a plurality of plasma tubes arranged in parallel; a plurality of display electrodes provided on a front side of the plasma tube array so as to be extended perpendicularly to a longitudinal direction of the plasma tubes; a plurality of address electrodes extended along each plasma tube longitudinally; wherein the plasma tubes each having a discharge assisting film provided on an inner surface of the tube and comprises, at the front side, a surface layer including at least one metal oxide selected from the group consisting of MgO, CaO, BaO and SrO; and magnesium oxide crystal particles partly emerging from the surface layer, and comprises, at a rear side, only the surface layer and no magnesium oxide crystal particles, and a phosphor film is formed on the surface layer on the rear side.

The present invention can provide a plasma tube and a display device having shortened discharge time lag and therefore having uniform discharge characteristics, because the discharge assisting film including magnesium oxide crystal particles is formed on the inner surface of each plasma tube at the front side which faces the display electrodes and serves as a discharge surface, and therefore crystal faces of the magnesium oxide crystal particles emerging in discharge spaces contribute to increase in secondary electron emission from the discharge assisting film.

### BRIEF DESCRIPTION OF THE DRAWINGS

FIG. 1 is an explanatory diagram illustrating a configuration of Embodiment 1 of a display device of the present invention;

FIG. 2 is a cross-sectional view taken along a line A-A in FIG. 1;

FIG. 3 (A) is a side cross-sectional view illustrating a production step of the display device of the present invention in which a material solution for discharge assisting film formation is injected into a glass tube;

FIG. 3 (B) is a side cross-sectional view illustrating a production step of the display device of the present invention in which the glass tube is allowed to rest;

FIG. 3 (C) is a side cross-sectional view illustrating a production step of the display device of the present invention in which a solvent component is released out of the glass tube;

FIG. 3 (D) is a side cross-sectional view illustrating a production step of the display device of the present invention in which a discharge assisting film is formed selectively on an inner surface of a lower flat face of the glass tube through firing;

FIG. 4 is a schematic cross-sectional configuration illustrating a rotary table of a spinner to be used in the production steps illustrated in FIGS. 3 (B) and 3 (C);

FIG. 5 (A) is a cross-sectional view illustrating the glass tube having a phosphor film formed on the inner surface of a flat face opposite the discharge assisting film having a larger thickness after the production step illustrated in FIG. 3 (D);

FIG. 5 (B) is a cross-sectional view illustrating the glass tube having a phosphor film formed, via a support, on the inner surface of the flat face opposite the discharge assisting film having a larger thickness after the production step illustrated in FIG. 3 (D);

FIG. 6 is a cross-sectional view illustrating Embodiment 2 of the display device of the present invention;

FIG. 7 is a cross-sectional view illustrating a modification of a plasma tube in the display device of Embodiment 2;

FIG. 8 is a drawing showing waveforms representing discharge characteristics of the plasma tube of the present invention measured with an oscillograph; and

FIG. 9 is a drawing showing waveforms representing discharge characteristics of a conventional plasma tube measured with an oscillograph.

### DESCRIPTION OF THE PREFERRED EMBODIMENTS

The display device of the present invention comprises a plasma tube array including a plurality of plasma tubes arranged in parallel, a display electrode sheet provided on a front side of the plasma tube array, and an address electrode sheet provided on a rear side of the plasma tube array.

The plasma tubes each have a glass tube, a discharge assisting film provided on an inner surface of the glass tube, a phosphor film provided on a rear-side part of the inner surface of the glass tube, and a discharge gas enclosed in the glass tube.

The display electrode sheet has a first support and a plurality of display electrodes formed on the first support so as to be extended perpendicularly to the glass tubes and arranged in parallel in the longitudinal direction of the glass tubes.

The address electrode sheet has a second support and a plurality of address electrodes formed on the second support so that each address electrode is extended along each glass tube. The second support may be omitted when the address electrodes are formed directly on outer surfaces of the plasma tubes.

The display device of the present invention is characterized in that the discharge assisting film has a larger thickness in an area at the front side than in an area under the phosphor film at the rear side.

The method for producing the display device having such a characteristic comprises the steps of: preparing a plurality of gas discharge plasma tubes; forming a display electrode sheet; forming an address electrode sheet; and forming a plasma tube array by arranging the plurality of plasma tubes in parallel between the display electrode sheet and the address electrode sheet. Of the steps, the present invention is characterized by the step of preparing the gas discharge plasma tubes, especially by a method for forming the discharge assisting film on the inner surface of the plasma tubes.

Specifically, the step of preparing the plasma tubes comprises the steps of: injecting a material solution for the formation of the discharge assisting film into glass tubes to serve as envelopes of the plasma tubes; allowing the glass tubes containing the material solution to rest horizontally for a predetermined period of time; releasing the material solution (solvent component) out of the glass tubes; and drying and firing a solid component left (precipitated) thick on a part of an inner surface of each glass tube to form a discharge assisting film, the part having been positioned at the bottom side in the step of allowing the glass tubes to rest. Thus, the discharge assisting film having a necessary thickness is formed on a part of the inner periphery of the glass tube when viewed on a cross-sectional view. Subsequently, a phosphor film is provided directly or indirectly via a supporting member on an opposite part where the discharge assisting film has been hardly formed or formed very thin. Thereafter, each glass tube is filled with the discharge gas and sealed at both ends, thereby completing the plasma tubes.

The discharge assisting film is composed of at least one metal oxide selected from the group consisting of MgO, CaO, BaO and SrO, and most preferably composed of magnesium oxide. The discharge assisting film may be composed of a complex oxide of magnesium oxide and calcium oxide. The discharge assisting film may include a small amount of rare-earth oxide such as, for example, cerium oxide (CeO₂). Furthermore, the discharge assisting film composed of an oxide of a Group IIA element such as MgO may include magnesium oxide crystal particles partly emerging from the surface of the discharge assisting film.

Thereby, a discharge assisting film having superior discharge characteristics can be obtained.

Each of the glass tubes to be the plasma tubes may be a horizontally long or vertically long flattened tube having major and minor diameters, and having one or two pairs of opposing flat faces along either one or both of the major and minor diameters. That is, each glass tube may have a flat elliptical (oval) or flat quadrate (rectangular) cross section. This is advantageous because the pair of flat faces of each flattened tube are positioned at the display surface side and the non-display surface side of the plasma tube array. According to this configuration, areas of contact between the respective flat faces of the plasma tubes and the display electrodes and the address electrodes can be increased. Accordingly, assembly of the plasma tube array is facilitated, and the discharge characteristics are stabilized and uniformed throughout the discharge points (discharge cells) in the longitudinal direction of the plasma tubes.

Alternatively, in this case, the opposing flat faces along the major diameter of each flattened tube may be oriented so as to face the flat faces of adjacent flattened tubes, that is, so that each plasma tube has a cross section vertically long based on the display surface in the plasma tube array. According to this configuration, the width of a unit light emission area in the direction in which the plasma tubes are arranged in parallel can be decreased without causing lowering of the luminance due to decreased surface areas of the phosphor films. Accordingly, the resolution of the display device can be increased.

The shape of the cross sections of the plasma tubes is not particularly limited and may be a circle, or a square or rectangle having rounded corners other than the flat oval. The diameter and the material of the plasma tubes are not particularly limited, either, and may be used a glass (borosilicate glass, for example) tube having a diameter of approximately 0.5 to 5 mm, for example.

The phosphor film provided in each plasma tube may be directly formed on the discharge assisting film having a smaller thickness at the rear side of the glass tube. As another configuration, the phosphor film may be provided in the form of a trough-shaped support supporting the phosphor film and being inserted in the glass tube to be placed at the non-display surface side. According to this configuration, the phosphor film can be formed in each plasma tube more readily.

The magnesium oxide particles have a crystal structure composed of two or more of a (100) crystal face, a (110) crystal face and a (111) crystal face.

The magnesium oxide crystal particles included in the discharge assisting film on a front-side part of the inner surface of each tube may have a diameter larger than a film thickness of the surface layer composing the discharge assisting film. This configuration helps the surfaces of the magnesium oxide crystal particles to partly emerge from the surface layer in the discharge assisting film.

Hereinafter, embodiments of the PTA-type display device and the method for producing the same of the present invention will be described in detail with reference to the drawings.

### Embodiment 1

### Configuration of PTA

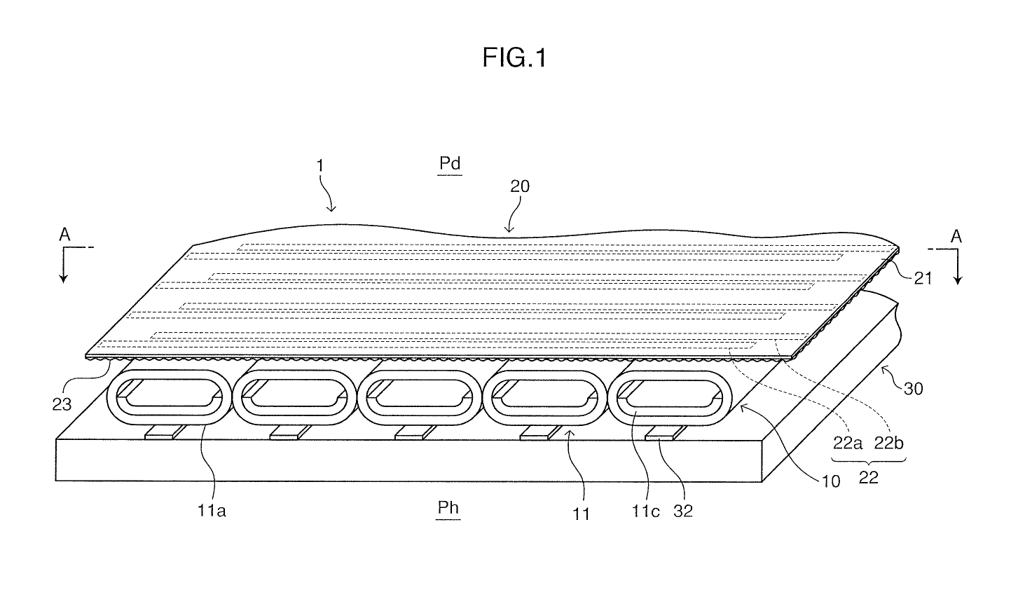

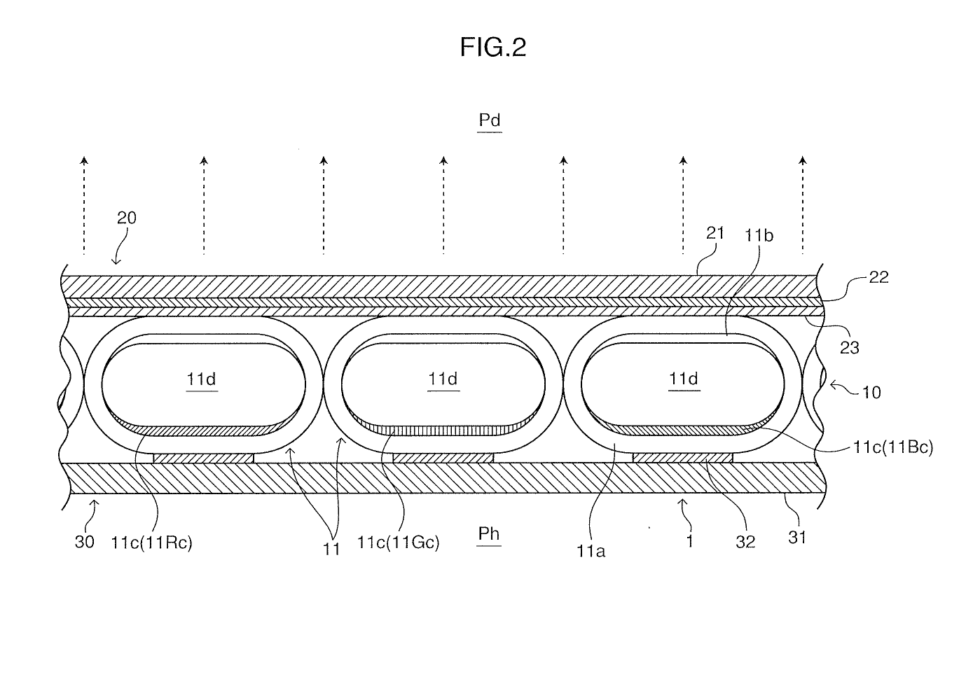

As illustrated in FIGS. 1 and 2, a display device 1 of Embodiment 1 includes a plasma tube array 10, a display electrode sheet 20 and an address electrode sheet 30. In the display device 1, the display electrode sheet 20 is at a front side, that is, at a display surface side Pd, and the address electrode sheet 30 is at a rear side, that is, at a non-display surface side Pn opposite to the display surface side Pd. The display device 1 is referred to as plasma tube array (PTA) type display device.

The plasma tube array 10 includes a plurality of plasma tubes 11 arranged in parallel.

Each plasma tube 11 has a flattened glass tube 11a whose both ends are sealed, a discharge assisting film 11b provided on an inner surface of the glass tube 11a, a phosphor film 11c provided on the inner surface of the glass tube 11a in an area at the rear side, that is, at the non-display surface side, and a discharge gas 11d enclosed in the glass tube 11a. Examples of the discharge gas 11d include neon, xenon and a gas mixture thereof.

In the plasma tube array 10, each plasma tube 11 is oriented so that one of its opposing flat faces faces the display surface side Pd, that is, the front side, and the other faces the non-display surface side Pn, that is, the rear side.

The discharge assisting film 11b formed on the inner surface of each plasma tube 11 has a larger thickness at the display surface side Pd than at the non-display surface side Pn. The thickness of the discharge assisting film 11b at the display surface side Pd is, for example, approximately 50 to 800 nm, preferably 100 to 500 nm, and particularly preferably 150 to 300 nm. The thickness of the discharge assisting film 11b at the non-display surface side Pn is, for example, approximately 0 to 300 nm, preferably 10 to 150 nm, and particularly preferably 0 to 50 nm. The difference between the thickness of the discharge assisting film 11b at the display surface side Pd and the thickness at the non-display surface side Pn is approximately 50 to 500 nm, preferably 100 to 400 nm, and particularly preferably 150 to 250 nm. Since the thickness of the discharge assisting film 11b at the non-display surface side Pn is very small compared to the thickness at the display surface side Pd or substantially zero, the discharge assisting film 11b at the non-display surface side Pn is not shown in FIG. 2.

As illustrated in FIGS. 1 and 2, red, green and blue phosphor films 11Rc, 11Gc and 11Bc are formed on rear-side parts of the inner surfaces of three adjacent plasma tubes 11, respectively, and the order of the three colors of phosphor films 11Rc, 11Gc and 11Bc is repeated in the plasma tube array 10. Each phosphor film 11c has a thickness of 10 to 50 μm, for example.

The display electrode sheet 20 has a first support 21, a plurality of display electrodes 22 formed on an lower surface of the first support 21 to be extended perpendicularly to the plasma tubes 11 and arranged in parallel in the longitudinal direction of the plasma tubes 11, and an adhesion layer 23 placed on the display electrodes 22 on the first support 21.

The first support 21 is composed of a transparent and flexible film such as a PET film or a polycarbonate film having a thickness of approximately 0.5 mm, for example.

The display electrodes 22 are display electrode pairs each consisting of a scanning electrode 22a and a sustain electrode 22b formed on the lower surface of the first support 21 so as to face the plasma tube array 10 and so as to be extended perpendicularly to the longitudinal direction of the plasma tubes 11 as described above.

The scanning electrode 22a is composed of a transparent electrode such as ITO formed on the first support 21 and a bus electrode of a film of a metal such as Cu and Cr formed on the transparent electrode, for example. These electrodes can be formed by a printing method or a low-temperature sputtering method commonly known in the art. The sustain electrode 22b may be formed in the same manner as in the scanning electrode 22a. Alternatively, these display electrode pairs may be formed of a mesh-patterned wire of a metal such as Cu and Al.

The width of the scanning electrode 22a and the sustain electrode 22b is 0.75 mm, for example, and the distance between the scanning electrode 22a and the sustain electrode 22b in each display electrode pair is 0.4 mm, for example. In addition, adjacent display electrode pairs are provided with a non-discharge gap constituting a band-shaped non-display region having a width of 1.1 mm, for example.

The address electrode sheet 30 has a second support 31, a plurality of address electrodes 32 formed on the second support 31 so that each address electrode 32 is extended along each plasma tube 11, and an adhesion layer (not shown) placed on the address electrodes 32 on the second support 31.

As in the case of the first support 21, the second support 31 may be formed of a flexible film but does not need to have a light-transmitting property. Rather, it is preferred that the second support 31 has a dark color for higher background contrast. Alternatively, the second support 31 may be formed of bendable thin soda-lime glass. However, the second support is not necessary when the address electrodes are formed directly on respective outer walls along the longitudinal direction of the plasma tubes by printing a silver paste, for example.

Each of the address electrodes 32 generates a discharge for selection of a light emission area between the address electrode 32 and a scanning electrode 22a of the display electrodes 22. The address electrodes 32 may be formed of a metal conductor such as Ag or Cu on the second support 31 at the non-display surface side Pn, which does not need to transmit light, by a printing method or a low-temperature spattering method commonly known in the art.

In the display device 1 having such a configuration, a selection discharge is generated at an intersection between a scanning electrode 22a of the display electrodes 22 and an address electrode 32 to select a light emission area, a wall charge is formed with the light emission on a surface layer of the discharge assisting film 11b on the inner surface of the glass tube 11a in the light emission area, and the wall charge is used to generate a display discharge between the scanning electrode 22a and the sustain electrode 22b (display electrode pair). The display discharge causes generation of ultraviolet photons in the plasma tube 11, and with the ultraviolet photons the phosphor film 11c generates excitation light. Thereby, the unit light emission area emits light as represented by dotted arrows in FIG. 2. As an alternative electrode structure, instead of the display electrode pair, one display electrode may be used as a scanning electrode, and the selection discharge and the display discharge may be generated between the scanning electrode and the address electrode.

### <Method for Producing Plasma Tube>

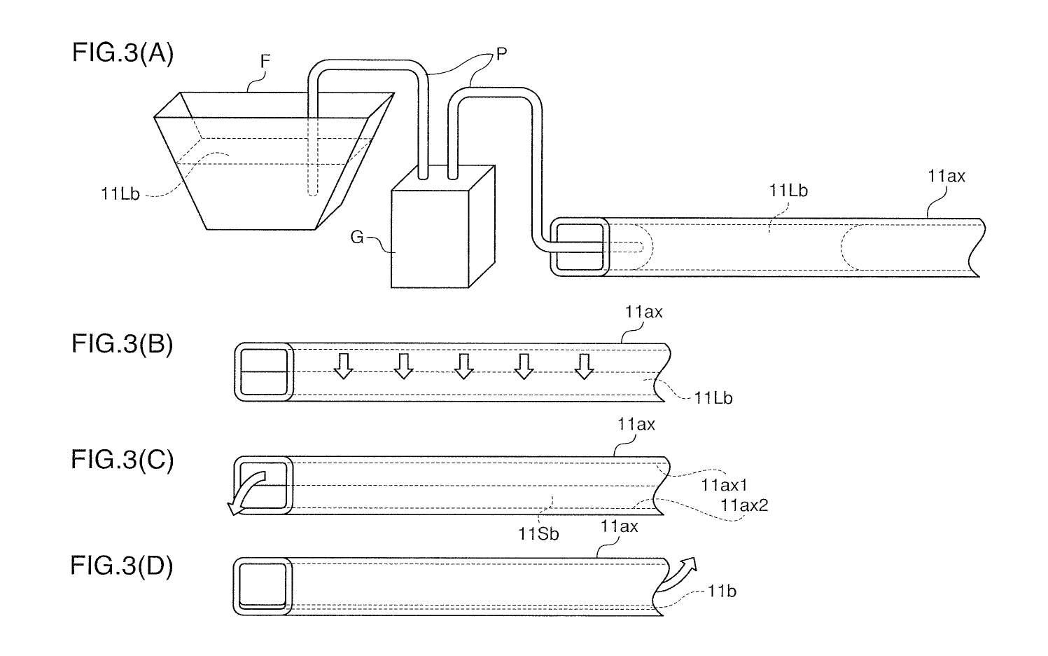

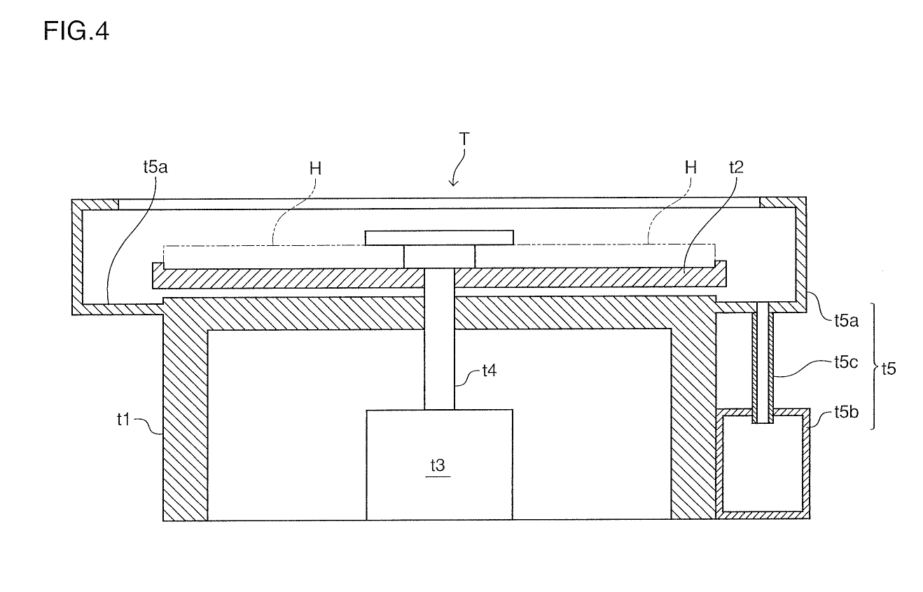

The plasma tubes 11 having the above-described configuration in the PTA type display device are produced by a solution injecting step (FIG. 3 (A)), a resting step (FIG. 3 (B)), a solvent releasing step (FIG. 3 (C)), and a firing step (FIG. 3 (D)). Hereinafter, the steps for producing the plasma tubes 11 of Embodiment 1 will be described. FIG. 4 illustrates a configuration of a spinner to use in the production.

### [Solution Injecting Step]

In the solution injecting step, a material solution 11Lb for discharge assisting film formation is injected into a glass tube 11ax having unsealed opposite end openings as illustrated in FIG. 3 (A). The glass tube flax is made of borosilicate glass having a flat elliptical or approximate quadrate cross section, for example, and has a length of 10 to 200 cm, which defines one length of a display screen.

The method of injecting the material solution 11Lb into the glass tube 11ax is not particularly limited, and any method may be used. In FIG. 3 (A), for example, a pipe P for sending the solution is connected to one end opening of the glass tube flax, the material solution 11Lb in a material solution tank F is supplied to the pipe P with an injector G, and then injected into the glass tube 11ax from the pipe P till it pours out from the other end opening of the glass tube 11ax. The glass tube 11ax is so thin that the material solution 11Lb injected stays inside unless otherwise caused.

When a magnesium oxide (MgO) film is formed as the discharge assisting film, the material solution 11Lb can be obtained by preparing a solution containing a carboxylic acid magnesium salt, a surfactant, an alcohol mixture and water mixed in predetermined proportions.

Examples of the carboxylic acid magnesium salt which is an organometallic compound to be used as a precursor of a magnesium oxide include, but are not limited to, magnesium acetate tetrahydrate, magnesium citrate, DL-aspartic acid magnesium salt tetrahydrate and magnesium caprylate.

Examples of the surfactant include, but are not limited to, polyoxyethylene alkyl ether, polyoxyethylene lauryl ether and polyoxyethylene nonyl phenyl ether.

Examples of alcohols in the alcohol mixture include, but are not limited to, ethanol, ethyleneglycol and glycerol.

In the material solution 11Lb, the proportion of the carboxylic acid magnesium salt is approximately 5 to 15% by weight, the proportion of the surfactant is approximately 10 to 20% by weight, the proportion of the alcohol mixture is approximately 55 to 70% by weight, and the proportion of the water is approximately 5 to 15% by weight. It is effective in terms of stabilization of the discharge assisting film to add a precursor of a rare-earth oxide, preferably a precursor of cerium oxide in a proportion of approximately 5 to 0.05% by weight to the carboxylic acid magnesium salt as the precursor of the magnesium oxide.

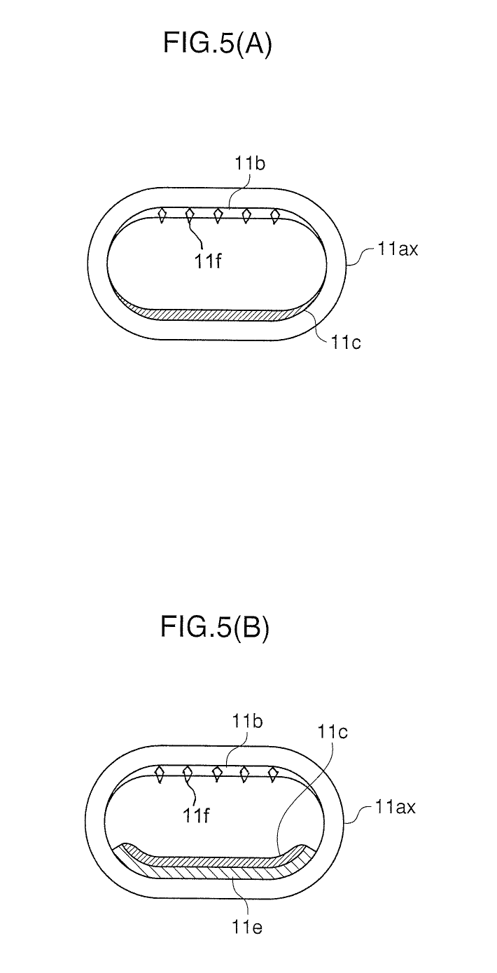

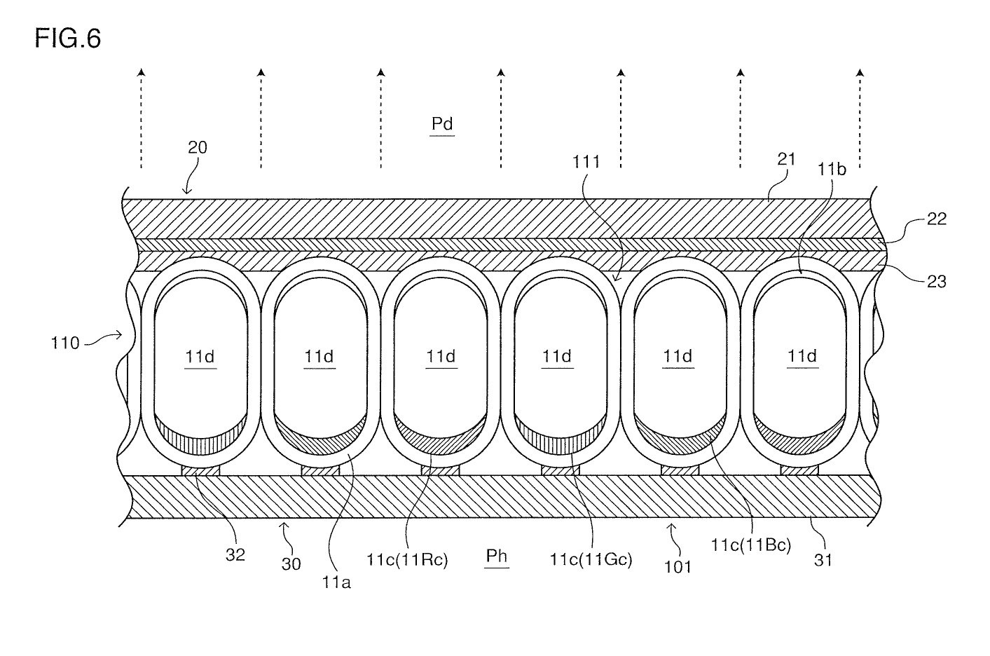

When magnesium oxide crystal particles are to be included in the discharge assisting film, magnesium oxide particles are added to the material solution. In this case, the discharge assisting film 11b will have a structure including a magnesium oxide surface layer illustrated in FIGS. 5 and 6, and magnesium oxide crystal particles 11f, which are representatively shown in the drawings, partly emerging from the surface layer. The magnesium oxide crystal particles 11f to be added are selected from those having an average particle diameter in a range from 20 to 20000 nm by classification according to the thickness of the discharge assisting film to be formed. To give an indication, magnesium oxide crystal particles having a particle diameter larger than the thickness of the magnesium oxide surface layer are selected so that the particles partly emerge from the surface layer.

In this case, the magnesium oxide particles can be obtained by uniformly heat-treating a high purity magnesium compound (MgO precursor) in an oxygen-containing atmosphere at a temperature of 500° C. or more.

Examples of the magnesium compound usable as the MgO precursor include magnesium hydroxide, magnesium alkoxide, magnesium acetylacetone, magnesium nitrate, magnesium chloride, magnesium carbonate, magnesium sulfate, magnesium oxalate and magnesium acetate. They may be used independently, or two or more kinds may be used in combination. In addition, hydrates of these magnesium compounds may be used.

Alternatively, commercially available magnesium oxide particles may be used, and examples thereof include “high-purity and ultrafine magnesia powder” (trade name) manufactured by Ube Material Industries, Ltd. Preferably, the magnesium oxide crystal particles have a crystal structure composed of two or more of 100, 110 and 111 planes.

### [Resting Step]

Following the solution injecting step, a plurality of glass tubes flax are set horizontally on a rotary table T of a spinner illustrated in FIG. 4 and allowed to rest for a predetermined period of time as illustrated in FIG. 3 (B).

First, the glass tubes 11ax containing the material solution 11Lb (see FIG. 3 (B)) are set in holders H as illustrated in FIG. 4 with their flat faces facing down. The holders H are cases each having a quadrate cross section and openings at opposite ends. Then, the plurality of (for example, four) holders H each having the glass tubes 11ax with their pairs of flat faces kept horizontal are fixed in a radial fashion on the rotary table T of the spinner for the resting step. That is, the glass tubes are allowed to rest in this state for a predetermined period of time thereby to cause the magnesium salt component or the magnesium salt component and the magnesium oxide crystal particles in the material solution to be precipitated on the lower flat face of each glass tube. The suitable resting time is approximately 1 to 60 minutes, which depends on the viscosity of the material solution prepared.

### [Solvent Releasing Step]

After the resting for a predetermined period of time, the solvent component of the material solution in the glass tubes flax is centrifuged out as illustrated in FIG. 3 (C) by rotating the rotary table T. In the solvent releasing step (spinning step), the rotary table T is rotated at a predetermined rotation speed for a predetermined rotation time. The rotation speed of the rotary table T is approximately 20 to 3000 rpm, and the rotation time is 100 to 1000 seconds, for example.

Thus, the solvent component is released out of the glass tubes 11ax through the end openings at the periphery side of the rotary table. Then, the rotary table T is stopped. As a result, a thicker coating film 11Sb composed of the magnesium salt component and a macromolecular filler component is formed on an inner surface 11ax₂ of the lower flat face of each glass tube 11ax, and a thinner coating film or no coating film is formed on an inner surface 11ax₁ of the upper flat face as illustrated in FIG. 3 (C).

Here, the rotary table T of the spinner will be briefly described with reference to FIG. 4. The rotary table T has a base t1, a disk t2 rotatably provided on the base t1, a motor t3 provided inside the base t1, a shaft t4 connecting the disk t2 and the motor t3, and a material solution collection section t5. The material solution collection section t5 includes a cover wall t5a provided along an upper external peripheral surface of the base t 1 and defining a groove t5a₁, a material solution collection box t5b, and a pipe t5c connecting the groove t5a₁ and the material solution collection box t5b. With the rotary table T having such a configuration, the material solution 11Lb (solvent component) centrifuged out from the glass tubes flax collides against an inner surface of the surrounding wall of the cover wall t5a to be accumulated in the groove t5a₁, and then collected in the material solution collection box t5b through the pipe t5c. The material solution 11Lb (solvent component) collected in the material solution collection box t5b can be reused.

### [Firing Step]

In the firing step, the discharge assisting film is fired by applying heat to the coating film. FIG. 3 (D) illustrates the discharge assisting film 11b fired and fixed on the inner surface of a glass tube 11ax. Optionally, a step of drying the coating film may be added between the solvent releasing step and the firing step. The drying step and the firing step are carried out under heating with airflow provided in the glass tubes 11ax. The drying temperature is 80 to 200° C., and the drying time is 1 to 20 hours, for example. The firing temperature is 450 to 650° C., and the firing time is 1 to 50 hours, for example. The airflow rate is 2 to 200 cc/m, for example.

As a result of the firing step, the discharge assisting film 11b having a thickness of approximately 50 to 800 nm is formed on the inner surface 11ax₂ of the glass tube 11ax, and the discharge assisting film 11b having a thickness of 50 nm or less is formed on the inner surface 11ax₁ as illustrated in FIG. 3 (D). In the case where the magnesium oxide crystal particles are added to the material solution as described above, the surfaces of the magnesium oxide crystal particles partly emerge from the surface of the discharge assisting film having the larger thickness on the inner surface of the lower flat face of each glass tube 11ax on the rotary table T. On the other hand, the discharge assisting film having the smaller thickness on the inner surface of the upper flat face of each glass tube 11ax on the rotary table T includes substantially no magnesium oxide crystal particles. The discharge assisting film 11b does not need to be formed on the inner surface 11ax₁ of the upper flat face.

### [Next Other Steps]

Subsequently, the glass tubes 11ax are turned upside down so that the discharge assisting film 11b having the larger thickness comes to top, and the phosphor film 11c is formed on the discharge assisting film having the smaller thickness as illustrated in FIG. 5 (A).

The phosphor film 11c is formed by introducing a phosphor slurry into each glass tube, precipitating the phosphor on the discharge assisting film having the smaller thickness, and firing the phosphor precipitated as disclosed in Yamada et al., U.S. Pat. No. 6,857,923 for example. Alternatively, a support boat 11e supporting the phosphor film 11c is prepared by applying and firing a phosphor paste on a support having a boat shape corresponding to the shape of the inner surface of the glass tubes flax, and inserted into each glass tube flax to be placed so that the phosphor film 11c is opposed to the discharge assisting film 11b having the larger thickness as illustrated in FIG. 5 (B). As the support boat 11e, one formed of the same borosilicate glass as the material of the glass tubes flax may be used.

Then, the one end opening of the respective glass tubes is sealed, thereafter, the discharge gas 11d is introduced into each glass tube 11ax, and the other end opening of each glass tube 11ax is sealed. Thus, the plasma tubes 11 are completed. In the case of the insertion of the phosphor support boat 11e into each glass tube 11ax, the distance between the bottom of the boat and the inner surface of the glass tube may vary from part to part to result in different electrostatic capacitances, and therefore the discharge characteristics may vary from part to part if the magnesium oxide crystal particles are dispersed in a part of the inner surface of the glass tube to contact the bottom of the support boat. Preferably, therefore, the rear-side part of the inner surface of each glass tube on which the phosphor support boat is provided according to the configuration of the present invention has no discharge assisting film and no crystal particles.

### Embodiment 2

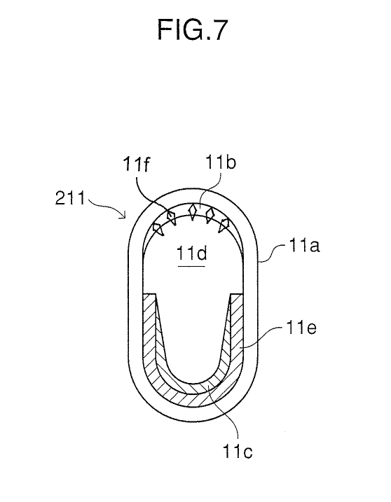

FIG. 6 is a cross-sectional view illustrating Embodiment 2 of a display device of the present invention. FIG. 7 is a cross-sectional view illustrating a modification of a plasma tube in the display device of Embodiment 2. In FIGS. 6 and 7, the same components as those in FIGS. 1 to 5 are represented by the same reference numerals. According to this Embodiment 2, it become possible to provide a PTA-type display device with high resolution.

In a plasma tube array 110 in a display device 101 of Embodiment 2, plasma tubes 111 (flattened tubes) are arranged so that the cross section of each plasma tube is vertically long and each major diameter is perpendicular to the display electrode sheet 20 and to the address electrode sheet 30. In this case, the discharge assisting film 11b having a larger thickness is formed on a curved inner surface of each glass tube 11a at the display surface side Pd, the discharge assisting film 11b having a smaller thickness is formed on a curved inner surface of each glass tube 11a at the non-display surface side Pn, and the phosphor film 11c is formed on the discharge assisting film having a smaller thickness. Although, the phosphor film 11c in FIG. 6 is formed directly on the rear side inner surface of the tube 11a, but the phosphor film 11c in FIG. 7 is supported on the support boat and inserted in the tube 11a as same as in case of FIG. 5(B).

In practice, the vertically long cross section of the flattened tubes in FIGS. 6 and 7 is a vertically long approximate quadrate cross section. That is, the flat glass tubes 11a having the vertically long cross section whose curved surfaces are exaggeratingly drawn in the figures each have opposing flat faces on top and bottom walls.

### Example 1

Plasma tubes each including a discharge assisting film and a phosphor film supported by a support, and being filled with a discharge gas (see FIG. 5 (B)) were prepared as follows.

First, 15% by weight of magnesium acetate tetrahydrate, 10% by weight of pure water and 20% by weight of polyoxyethylene alkyl ether were mixed with an alcohol mixture of 25% by weight of ethanol, 10% by weight of ethyleneglycol and 20% by weight of glycerol to give a material solution for discharge assisting film formation (for surface layer formation).

Next, a glass tube having a length of 1 m and a flat elliptical cross section with a major diameter of 1 mm and a minor diameter of 0.5 mm was filled with the material solution for discharge assisting film formation. A set of 200 glass tubes thus filled with the material solution was laid in a holder, and four holders were set in a radial fashion on a rotary table of a spinner. Thereafter, the glass tubes were allowed to rest for 20 minutes, and then the rotary table was rotated for 260 seconds to let excess material solution (solvent component) out from the glass tubes. The rotary table was rotated and stopped by adjusting the rotation speed in a range from 0 to 500 rpm.

Next, the glass tubes removed from the rotary table were set in a firing furnace, and drying was performed for 11 hours (660 minutes) under air flow maintained at a rate of 1.5 cc/m. The drying temperature was adjusted in a range from 25 to 120° C. Thereafter, firing was performed for 27 hours (1620 minutes) thereby to form a discharge assisting film made of magnesium oxide on an inner surface of each glass tube. The air flow rate was adjusted in a range from 0 to 29 cc/m, and the firing temperature was adjusted in a range from 25 to 500° C.

The discharge assisting film formed had a thickness of 300 nm on an inner surface of a lower flat face of each glass tube and a thickness of 30 nm on an inner surface of an upper flat face.

Subsequently, one end opening of each glass tube was sealed flat with low-melting glass, and then a support having a phosphor film preliminarily formed on an inner surface thereof (U-shaped phosphor support boat) was inserted into each glass tube to be placed opposite the discharge assisting film having the larger thickness. Next, the air in each glass tube was replaced with a gas mixture of neon and xenon, and then the other end opening of each glass tube was sealed flat with low-melting glass. Thus, the plasma tubes were prepared. The discharge voltages in the respective discharge points in the longitudinal direction of each plasma tube were measured, and variations of the minimum sustaining voltage (surface discharge voltage between electrode pair) and variations of the address voltage (breakdown voltage between scanning electrode and address electrode) among the discharge points were both in tolerable ranges for practical use.

### Example 2

Plasma tubes were prepared in the same manner as in Example 1 except that the material solution for discharge assisting film formation (for surface layer formation) and the resting time of the glass tubes before the release of the excess material solution (solvent component) were changed as follows.

The material solution for discharge assisting film formation (for surface layer formation) used here was prepared by mixing 10% by weight of magnesium citrate, 10% by weight of pure water and 15% by weight of polyoxyethylene lauryl ether with an alcohol mixture of 30% by weight of ethanol, 20% by weight of ethyleneglycol and 15% by weight of glycerol. The resting time was changed to 30 minutes.

As a discharge assisting film of Example 2, a magnesium oxide film formed on an inner surface of a lower flat face of each glass tube had a thickness of 200 nm, and a magnesium oxide film formed on an inner surface of an upper flat face had a thickness of 20 nm. The plasma tubes prepared had as satisfactory discharge characteristics as in Example 1.

### Example 3

In Example 3, magnesium oxide particles were included in the discharge assisting film 11b, and the surfaces of the magnesium oxide particles partly emerged from the discharge assisting film 11b. Other than that, the materials and the configuration were substantially the same as in Example 1. Plasma tubes each having a discharge assisting film including the MgO crystal particles and a phosphor film therein, and being filled with a discharge gas were prepared as follows.

First, 15% by weight of magnesium acetate tetrahydrate, 10% by weight of pure water and 20% by weight of polyoxyethylene alkyl ether were mixed with an alcohol mixture of 25% by weight of ethanol, 10% by weight of ethyleneglycol and 20% by weight of glycerol to give a material solution for forming a surface layer of a magnesium oxide discharge assisting film. Then, 5 parts by weight of magnesium oxide crystal particles having an average particle diameter of 1000 nm were mixed with and dispersed in 100 parts by weight of the material solution for the surface layer formation to give a material solution for discharge assisting film formation.

Next, a glass tube having a length of 1 m and a flat elliptical cross section with a major diameter of 1 mm and a minor diameter of 0.5 mm was filled with the material solution for discharge assisting film formation. A set of 200 glass tubes thus filled with the material solution was laid in a holder, and four holders were set in a radial fashion on a rotary table of a spinner. Thereafter, the glass tubes were allowed to rest for 20 minutes, and then the rotary table was rotated for 260 seconds to let the solvent component out from the glass tubes. The rotary table was rotated and stopped by adjusting the rotation speed in a range from 0 to 500 rpm.

Next, the glass tubes removed from the rotary table were set in a firing furnace, and drying was performed for 11 hours (660 minutes) under air flow maintained at a rate of 1.5 cc/m. The drying temperature was adjusted in a range from 25 to 120° C. Thereafter, firing was performed for 27 hours (1620 minutes) thereby to form a discharge assisting film composed of a magnesium oxide surface layer and magnesium oxide crystal particles partly emerging from the surface layer on an inner surface of one flat face of each glass tube. The air flow rate was adjusted in a range from 0 to 29 cc/m, and the firing temperature was adjusted in a range from 25 to 500° C.

The discharge assisting film formed on the inner surface of the lower flat face of each glass tube had a structure having a thickness of 300 nm as the magnesium oxide surface layer and including the magnesium oxide crystal particles partly emerging from the surface layer. On the other hand, the discharge assisting film on an inner surface of an upper flat face of each glass tube had a thickness of 30 nm and had no magnesium oxide crystal particles.

Subsequently, one end opening of each glass tube was sealed flat with low-melting glass, and then a support having a phosphor film preliminarily formed on one surface thereof (U-shaped phosphor support boat) was inserted into each glass tube to be placed opposite the discharge assisting film having the larger thickness. Next, the air in each glass tube was replaced with a gas mixture of neon and xenon, and then the other end opening of each glass tube was sealed flat with low-melting glass. Thus, the plasma tubes were prepared.

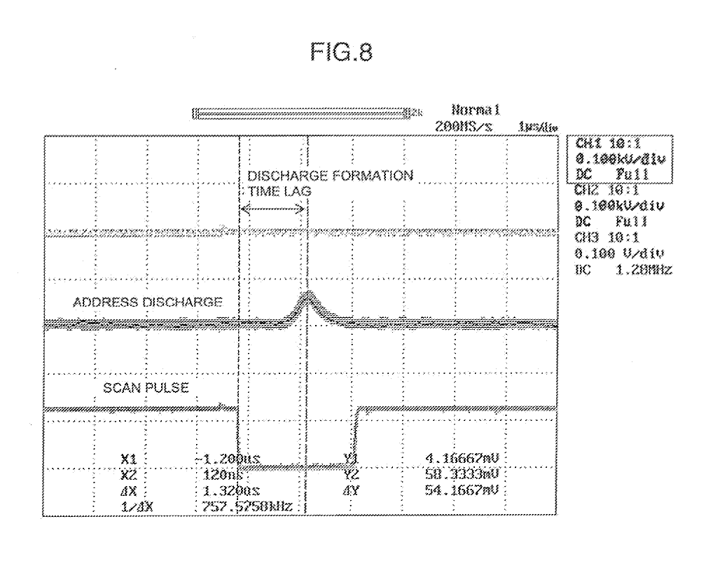

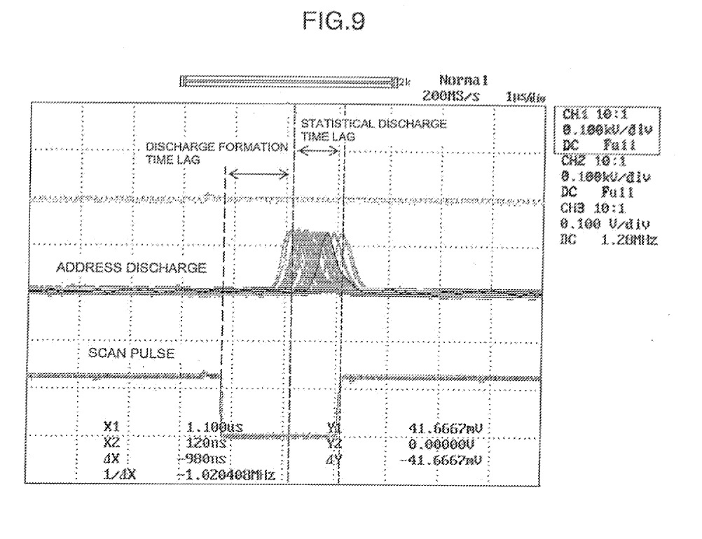

On the surface side of the thus prepared plasma tubes having a length of 1 m, 720 display electrode pairs were arranged so as to define 720 unit discharge areas (discharge cells) in the longitudinal direction of the plasma tubes, and address electrodes were arranged on the rear side so that each address electrode is extended along each plasma tube. Then, the discharge characteristics of the plasma tubes were measured with an oscillograph. FIG. 8 shows waveforms representing the discharge characteristics. As can be seen in FIG. 8, the measurement result of an address discharge current Da in each discharge cell indicates that the discharge formation time lag between the application of a scan pulse Ps having a width of 2 μs to an address electrode and the start of an address discharge was shortened in all the discharge cells, and the time lags in all the discharge cells were substantially the same, so that the statistical discharge time lag was decreased to almost zero. The improvement effect is found to be significant when the result is compared with the one shown in FIG. 9 which is the measurement result of conventional plasma tubes having no magnesium oxide crystal particles mixed in the discharge assisting film and in which the discharge time lags varied from discharge cell to discharge cell by a width of approximately 1 μs. As a result of the improvement in the discharge formation time lag and the statistical discharge time lag, high-speed addressing was achieved, and thereby secure and stable display operation was achieved even with a high-definition cell density.

### Example 4

Plasma tubes were prepared in the same manner as in Example 3 except that the material solution for discharge assisting film formation and the resting time of the glass tubes before the release of the excess material solution (solvent component) were changed as follows.

The material solution for forming a surface layer of a magnesium oxide discharge assisting film used here was prepared by mixing 10% by weight of magnesium citrate, 10% by weight of pure water and 15% by weight of polyoxyethylene lauryl ether with an alcohol mixture of 30% by weight of ethanol, 20% by weight of ethyleneglycol and 15% by weight of glycerol. Then, 5 parts by weight of magnesium oxide crystal particles having an average particle diameter of 1000 nm were mixed with and dispersed in 100 parts by weight of the material solution for the surface layer formation to give a material solution for discharge assisting film formation. The resting time was changed to 30 minutes.

In Example 4, the discharge assisting film formed on an inner surface of a lower flat face of each glass tube had a structure having a thickness of 200 nm as the magnesium oxide surface layer and including the magnesium oxide crystal particles partly emerging from the surface layer. On the other hand, the discharge assisting film on an inner surface of an upper flat face of each glass tube consisted only of a magnesium oxide layer having a thickness of 20 nm. In the plasma tubes of Example 4, as in the case of Example 3, the discharge characteristics were uniformed among the 720 discharge cells in the longitudinal direction of each plasma tube, and thereby the statistical discharge time lag was decreased to almost zero.

### Example 5

A precursor of magnesium oxide was prepared by adding 0.0033 parts by weight of cerium(III) acetate monohydrate [(CH₃COO)₃Ce.H₂O] to 1 part by weight of magnesium acetate tetrahydrate [Mg(CH₃COO)₂.4H₂O], and then 15% by weight of this synthetic precursor was mixed with the other components in the same amounts as in Example 1 to give a material solution for discharge assisting film formation.

The discharge assisting film of magnesium oxide formed by injecting this material solution had a structure having asymmetric film thicknesses like Example 1 and including cerium oxide. Addition of a small amount of cerium oxide to the discharge assisting film of magnesium oxide has an effect of preventing cracks in the discharge assisting film.

As a modification of Example 5, as in the case of Example 3 or 4, magnesium oxide crystal particles may be added to the material solution containing the precursor of cerium oxide to form a discharge assisting film.

As the precursor of cerium oxide, cerium hydroxide, cerium nitrate, cerium carbonate or a hydrate thereof may be appropriately used, and the amount thereof to add to the precursor of magnesium oxide is preferably 0.05 to 0.0005 parts by weight. Addition of the precursor of cerium oxide in an amount beyond this range is not preferable, because it tends to increase the discharge voltage.

While the discharge assisting film has been described as being made of magnesium oxide (MgO) in the Examples, the discharge assisting film may be made of CaO, BaO or SrO or made of a complex of two or more kinds thereof, each of which is an oxide of a Group IIA element having a high secondary electron emission efficiency γ, because the discharge assisting film is to serve to provide electrons for reducing the discharge voltage in the inner spaces of the plasma tubes being discharge spaces. Such a discharge assisting film may be formed with a material solution obtained by appropriately preparing and dissolving in a solvent an organometallic compound or an inorganic metal compound of a Group IIA element in the same manner as in the carboxylic acid magnesium salt.

What is claimed is:

1. A display device comprising:
a plasma tube array including a plurality of plasma tubes arranged in parallel and having front and rear sides;
a plurality of display electrodes provided on the front side across the plasma tubes; and
a plurality of address electrodes each provided along each plasma tube;
each plasma tube having a tube, a discharge assisting film having a thickness different from part to part, and a phosphor film, wherein
the discharge assisting film is provided on an inner surface of each tube, the thickness of the discharge assisting film is larger at the front side than at the rear side, and the phosphor film is formed on the discharge assisting film at the rear side.

2. The display device according to claim 1, wherein the discharge assisting film includes magnesium oxide crystal particles partly emerging from a surface of the discharge assisting film.

3. The display device according to claim 1, wherein each tube comprises a flattened glass tube having major and minor diameters; and a pair of flat faces parallel to the major diameter, and one of the pair of flat faces is used for the front side of the plasma tube array and provided with the discharge assisting film having the larger thickness.

4. The display device according to claim 1, wherein each tube comprises a flattened glass tube having an approximate quadrate cross section with a pair of long sides and a pair of short sides, and one of the pair of short sides is used for the front side and provided with the discharge assisting film having the larger thickness.

5. The display device according to claim 2, wherein the magnesium oxide crystal particles are included in the discharge assisting film only at the front side of the plasma tube array.

6. The display device according to claim 1, wherein the phosphor film is provided on the discharge assisting film having the smaller thickness while being supported on an inner surface of a trough-shaped phosphor support.

7. A plasma tube for use in a plasma tube array type display device comprising:
a grass tube having a flat quadrate shape in a cross section and at least a pair of flat opposing surfaces;
a discharge assisting film provided on inner surfaces of the pair of flat opposing surfaces, the discharge assisting film having a thinner thickness on one of the inner surfaces than on the other of the inner surfaces;
a phosphor film provided on the thinner discharge assisting film on the one of the inner surfaces; and
a discharge gas enclosed in the glass tube.

8. A method for producing the display device according to claim 1, the method comprising a step of forming the discharge assisting film having a thickness different from part to part on the inner surface of each tube to be the plasma tube,
the step of forming the discharge assisting film comprising steps of:
(a) injecting a material solution for discharge assisting film formation into each tube;
(b) allowing each tube containing the material solution to rest horizontally for a predetermined period of time with a display surface side of each tube facing down so that a discharge assisting film component is precipitated thick on the display surface side;
(c) releasing a solvent component of the material solution out of each tube; and
(d) firing the discharge assisting film component precipitated on the display surface side to form and fix the discharge assisting film having a larger thickness on a lower part of the inner surface of each tube than on an upper part of the inner surface of each tube.

9. The method according to claim 8, further comprising a step of providing glass tubes each having a flattened cross section, wherein the step (b) is carried out with each flattened glass tube resting horizontally and one flat face of each flattened glass tube facing down to form the discharge assisting film having a larger thickness on the flat face than on an opposing flat face.

10. The method according to claim 8, wherein the step (b) is carried out while the tubes containing the material solution for discharge assisting film formation are positioned on a horizontal rotary table of a spinner so that the tubes are radially set around a center of the rotary table, and the step (c) is carried out while the rotary table is rotated.

11. The display device according to claim 1, wherein the discharge assisting film comprises, at the front side, a surface layer including at least one metal oxide selected from the group consisting of MgO, CaO, BaO and SrO; and magnesium oxide crystal particles partly emerging from the surface layer, and comprises, at the rear side, only the surface layer and no magnesium oxide crystal particles, and
the phosphor film is formed on the discharge assisting film on the rear side.

12. The display device according to claim 11, wherein the magnesium oxide crystal particles included in the discharge assisting film have a diameter larger than a film thickness of the surface layer composing the discharge assisting film.

13. The display device according to claim 11, wherein each tube comprises a flattened glass tube having major and minor diameters and at least a pair of opposing flat faces, and one of the flat faces is used for the front side having the display electrodes and the other is used for the rear side having the address electrodes.

14. The display device according to claim 11, wherein each tube comprises a flattened tube having an approximate quadrate cross section with a pair of long sides and a pair of short sides, and a pair of opposing flat faces with the long sides or the short sides are positioned at the front side and the rear side of the plasma tube array, respectively.

15. The display device according to claim 11, wherein the phosphor film is provided on the discharge assisting film on the rear side while being supported on an inner surface of a trough-shaped support.

16. A plasma tube for use in the display device according to claim 1, comprising:
a tube having a flattened cross section;
a discharge assisting film provided on an inner surface of the tube;
a phosphor film provided in the tube; and
a discharge gas enclosed in the tube, wherein
the discharge assisting film comprises, on a front-side part of the inner surface of the tube, a magnesium oxide surface layer and magnesium oxide crystal particles partly emerging from the surface layer, and comprises, on a rear-side part of the inner surface of the tube, only the magnesium oxide surface layer, and
the phosphor film is formed on the magnesium oxide surface layer on the rear-side part.

17. A method for producing the display device according to claim 1, the method comprising a step of forming the discharge assisting film having a thickness different from part to part on the inner surface of each tube to be the plasma tube,
the step of forming the discharge assisting film comprising steps of:
(a) injecting, into each tube, a solution obtained by mixing magnesium oxide crystal particles with a material solution for discharge assisting film formation containing an organometallic compound of a Group IIA element;
(b) allowing each tube containing the material solution to rest horizontally for a predetermined period of time with a display surface side of each tube facing down so that a discharge assisting film component is precipitated on the display surface side;
(c) releasing a solvent component of the material solution out of each tube; and
(d) firing the component precipitated on the display surface side to form the discharge assisting film composed of a surface layer of an oxide of the Group IIA element and the magnesium oxide crystal particles partly emerging from the surface layer.

18. The method according to claim 17, further comprising a step of providing flattened glass tubes each having a approximate rectangular cross section, wherein
the step (b) is carried out while the glass tubes after the step (a) are set horizontally on a rotary table with one flat face of each glass tube facing down,
the step (c) is carried out while the rotary table is rotated, and then
the step (d) is carried out to form the discharge assisting film including the magnesium oxide crystal particles on an inner surface of the flat face.

19. The plasma tube according to claim 16, wherein the magnesium oxide surface layer includes cerium oxide.

20. The method according to claim 8 or 17, wherein the material solution for discharge assisting film formation comprises a mixed solution containing a precursor of magnesium oxide to which a precursor of cerium oxide has been added.
